(19) United States
(12) Patent Application Publication
(10) Pub. No.: US 2024/0193398 A1
(43) Pub. Date: Jun. 13, 2024

(54) METHOD, SYSTEM AND COMPUTER-READABLE MEDIUM

(71) Applicant: VOLKSWAGEN AKTIENGESELLSCHAFT, Wolfsburg (DE)

(72) Inventor: Yasin BAYZIDI, Braunschweig (DE)

(21) Appl. No.: 18/529,768

(22) Filed: Dec. 5, 2023

(30) Foreign Application Priority Data
Dec. 7, 2022 (EP) 22212090.9

(51) Int. Cl. G06N 3/02; G01S 17/931; G06V 20/58

(52) U.S. Cl. CPC G06N 3/02; G01S 17/931; G06V 20/584

(57) ABSTRACT

A method for assessing the reliability of a prediction made by a deep neural network includes inputting input data to a trained deep neural network, determining a class probability score of the detection, wherein the class probability score is determined by fitting of at least two multiple outlier detection methods, determining whether the input data is or is not an outlier, comparing the class probability score to a threshold value, and outputting that the prediction is or is not reliable. Also disclosed is a system and a computer readable storage medium.

### PRIORITY CLAIM

This patent application claims priority to European Patent Application No. 22212090.9, filed 7 Dec. 2022, the disclosure of which is incorporated herein by reference in its entirety.

### SUMMARY

Illustrative embodiments relate to a method, a system, and a computer-readable medium.

### BRIEF DESCRIPTION OF THE DRAWINGS

Disclosed embodiments are described in detail with reference to the drawings. The features mentioned in the claims and in the description may, in each case, be essential individually or in any combination.

FIG. 1 shows a schematic representation of an exemplary embodiment of a disclosed method;

FIG. 2 shows a schematic representation of a connection of the multiple outlier detection methods; and

FIG. 3 shows a schematic representation of a disclosed system.

### DETAILED DESCRIPTION

Advances in the development of deep neural networks (DNNs) in the recent years made vision based detection a primary tool for perception sub-systems within highly automated driving systems.

To detect objects and segment data based on semantics, these networks are usually trained based on annotated training data. The evaluation of such networks can be performed both with annotated (e.g., mean intersection over union (mIoU)) and non-annotated data (e.g., temporal consistency), depending on the evaluation method requirements.

However, the final prediction of a deep neural network is usually based on a highest class score among all the classes a deep neural network can classify. Without labels annotated by humans, it is still a challenge to evaluate a meaningful probability of the determined class as being correct or incorrect.

Present approaches to determine the reliability of a prediction of a deep neural network usually suffer from requiring equally or even more calculation power than the actual prediction of the class. This hinders the implementation of such methods in real-time applications.

In particular, in automated driving applications, the evaluation of predictions of classes is important, as decisions based on these predictions could be erroneous. There may be cases where the ranking of the classes already provides options to determine the certainty of the prediction in relation to the possible options. For example, when traffic signs are detected, a classification of the speed limit of 30 km/h with 50% and a speed limit with 70 km/h with 48% could, based on the small difference, mean that the prediction is not sufficiently reliable to automatically determine the speed with which the transportation vehicle should drive. However, there may even be cases where the machine learned neural network determines only a single class or a very high score for this single class and still be wrong.

Thus, there is a need for a real-time evaluation of predictions made by neural networks.

The disclosed embodiments at least partially eliminate the above-mentioned drawbacks known from the prior art. In particular, the disclosed embodiments provide a method, a system, and a computer-readable medium which provide a fast, reliable, low computational power and economic way of establishing an evaluation of predictions made by neural networks.

Disclosed embodiments provide a method, a system, and a computer. Features and details described in connection with the disclosed method naturally also apply in connection with the disclosed system and/or the disclosed computer, and vice versa in each case, so that reference is or can always be made mutually with regard to the disclosure concerning the individual disclosed embodiments.

According to a first exemplary embodiment, a method for assessing the reliability of a prediction made by a deep neural network is provided. The method comprises
inputting input data to a trained deep neural network, wherein the trained deep neural network is configured to output a detection based on a highest class score, in particular, by a processor that is configured to be arranged on a backend-computer and/or on a transportation vehicle,
determining a class probability score of the detection, wherein the class probability score is determined by fitting of at least two multiple outlier detection methods, wherein the at least two multiple outlier detection methods are configured to produce the class probability score, in particular, by the processor,
determining, based on the class probability score, whether the input data is an outlier or not, in particular, by the processor,
comparing the class probability score to a threshold value, in particular, by the processor,
outputting, that the prediction is reliable if the class probability score is above the threshold value, or outputting that the prediction is not reliable if the class probability score is below the threshold value, in particular, by the processor.

In other words, the first exemplary embodiment relates to a method for determining whether a prediction of a neural network is sufficiently valid. A deep neural network is used to make a prediction, in particular, a class prediction. The probability of this prediction is assessed by using at least two multiple outlier detection methods, wherein an evaluation is performed regarding whether the input data is an outlier or not, wherein a score is provided which is related to the chance of the input data being an outlier or not. Based on this chance, the method provides an assessment of whether the prediction made by the deep neural network is valid.

In the context of the present disclosure, a deep neural network can have more than one layer between input and output. In particular, the deep neural network can have at least 10 or optionally at least 100 layers between input and output. Further, the deep neural network can be configured as a convolutional neural network. Convolutional neural networks have the benefit of reducing the risk of overfitting and may have a better performance than a network with fully connected layers.

Input data can be any form of digitized information. This input data can be represented as a feature vector x. The input data can be data from a sensor, in particular, from a sensor that is arranged on a car. For example, the input data could comprise an image, in particular, of a traffic sign. Further examples are discussed in detail below.

In the context of the present disclosure, a detection of the trained deep neural network can be regarded as any form of prediction or evaluation. As an example, if an image taken from a camera mounted on a car is provided as input data for the deep neural network, the deep neural network may be configured to output a class score of traffic signs visible in the image, e.g., a “30 km/h” speed limit sign.

A class score can be considered to be a numerical value for the prediction of the deep neural network. For example, a class score could be 0.7 for a prediction of a “30 km/h” speed limit traffic sign. It can be provided that multiple labels can be predicted for one feature vector. For example, a single image could be labelled with “traffic sign”, “30 km/h” and “restriction relevant for this transportation vehicle (car)”. As an alternative or additionally, images can also be segmented before being added as a feature vector in the deep neural network. The highest class score determined by the deep neural network represents the prediction made by the deep neural network. Examples of such predictions can, e.g., be “red traffic light” or “car moving with 50 km/h in 15 m distance”.

A class probability score of the detection can be regarded as a numerical value representing a certainty of the prediction made by the deep neural network. In other words, the class probability score can be seen as a measure of the certainty and/or uncertainty of the data.

An outlier can be defined as an observation that does not conform to a model suggested by the homogeneous majority of the observations in a data set.

A multiple outlier detection method can be configured to determine whether output data of a deep neural network is an outlier or not. For a single outlier detection, the output could, e.g., be whether the input data is within the class (no outlier) or not (detection of an outlier). In multiple outlier detection methods, the last layer of the deep neural network can associate the input data to more than one class. Nonetheless, there may still be outliers outside of all possible classes. Multiple outlier detection methods are configured to determine whether the input data is outside of these classes. Examples of multiple outlier detection methods are discussed in more detail below.

A threshold value can be regarded as a value that is configured to be an engineered numerical value that represents a limit between a prediction of the deep neural network that can be trusted or not, that is specific to the prediction. For example, a prediction of a present weather state might require a lower threshold value compared to a prediction of a sufficient distance to a car for an emergency brake maneuver.

In the context of the present disclosure, outputting can be regarded as the transfer of information, whether the prediction made by the deep neuronal network is reliable or not. It can be provided that this information is used in a subsequent decision. This subsequent decision can, in particular, be a control command in a transportation vehicle, in particular, at least one of a velocity, a direction, or a maneuver, such as overtaking a transportation vehicle, stopping in front of a traffic light or changing lanes.

In summary, the present disclosure allows to determine the reliability of a prediction of a deep neural network at relatively low computational cost. This results in the applicability of the method in real-time situations, such as self-driving or partly self-driving transportation vehicles.

Within the scope of the disclosure, it is further conceivable that the class probability score is determined with respect to the at least two classes. In other words, two or more classes can be determined by the deep neural network. Determining at least one class allows to further evaluate the determined classes. Determining at least two classes has the benefit that multiple features can be used from a single input datum, i.e., an input feature vector.

Within the scope of the disclosure, it is further conceivable that at least one of the at least two multiple outlier detection methods is:
a gaussian mixture model,
a one class support vector machine,
a local intrinsic dimensionality,
a k-Means clustering,
a Mahalanobis distance, or
an isolation forest.

A gaussian mixture model (GMM) can be configured to allow for each input feature vector to be a member of several clusters with different membership scores. In particular, the Gaussian mixture model can comprise a weighted sum of several multivariate normal distributions. A gaussian mixture model has the benefit of performing well with patch-wise shapes of images and clusters.

A one class support vector machine (SVM) has the benefit of being adaptable to the specific task and of performing well for input data that comprises noise. It can be provided that a hinge loss function is implemented. This has the benefit of providing a reliable way to deal with noisy input data.

A local intrinsic dimensionality provides the possibility of making use of the fact that the input data is distributed on a lower-dimensional manifold when only considering a nearby subset of the data.

K-Means clustering algorithms are efficient and converge quickly in comparison to other models.

Mahalanobis distance has the benefit of providing a very good performance, in particular, with highly imbalanced input data.

Isolation forest explicitly isolates anomalies using binary trees. It has the benefit of being fast by directly targeting anomalies without profiling all normal instances. In particular, it is most efficient in high volume data and consumes very low memory.

It is further conceivable that at least two of the at least two multiple outlier detection methods differ from each other, wherein a first multiple outlier detection method is isolation forest and a second outlier detection method is a one class support vector machine. In other words, two different multiple outlier detection methods may be applied to determine a class probability score. This has the benefit that desirable properties of different multiple outlier detection methods can be combined to obtain a more reliable and/or efficient result for the validity of the prediction.

To use an isolation forest for the first multiple outlier detection and a one class support vector machine for the second outlier method has the benefit that this model would perform well for data that includes noise (one class support vector machine performing well) as well as data that has a large volume (isolation forest performing well).

It can further be provided that at least two of the at least two multiple outlier detection methods are of the same type, wherein different subsets of the input data are prepared and each of the different subsets is input in an outlier detection method of the same type, in particular, wherein the two multiple outlier detection methods are an isolation forest. In other words, two and/or all of the multiple outlier detection methods are of the same type and the input data is separated into at least two different input data parts, wherein the different parts are applied to the multiple outlier detection methods of the same type. This has the benefit that the best multiple outlier detection method can be used for a specific type of input data and that at the same time, the correlation between the methods can be reduced without using different multiple outlier detection methods.

Further, it can be provided that the subsets of the input data are selected by feature bagging. In other words, the subgroup of the input data may be chosen by feature bagging (also known as random subspace method or attribute bagging). Feature bagging has the benefit of avoiding focusing too strongly on features that are highly predictive/descriptive in the training data, but fail to be as predictive for points outside that set. This way, the correlation between the methods can be reduced without using different multiple outlier detection methods.

It can further be provided that a meta multiple outlier detection method is provided, which receives at least two probability scores from the at least two multiple outlier detection methods and determines a meta probability score. In other words, the method may comprise determining the class probability score on the basis of a probability score that is specific to the at least two probability scores from the at least two multiple outlier detection methods. This has the benefit that the results of all multiple outlier detection methods are used. For example, the meta probability score can be the average of the results from the at least two multiple outlier detection methods. Using the average is a computationally efficient way of obtaining a class probability score that is a meta probability score of the multiple outlier detection methods. Alternatively or in addition, more complex variations of determining the meta probability score may be provided, including further outlier detection methods.

Furthermore, a disclosed method provides that the input data comprises information of at least a traffic signal, a traffic light, a traffic participant, in particular, a pedestrians or a transportation vehicle, and/or wherein the input data is at least an image, a radar sensor signal, a LIDAR sensor signal or an ultrasonic sensor signal. In other words, the input data can be data of a transportation vehicle and/or be related to a data of a transportation vehicle. This has the benefit of using the real-time capabilities of the disclosed method in a situation where quick, reliable decision making is important to ensure the safety and comfort of the passengers in the transportation vehicle.

It is further conceivable the at least two multiple outlier detection methods are fitted to the activation of the output layer of the trained deep neural network. In other words, the activation of the output layer of the deep neural network making the prediction, in particular, a fully connected layer, can be used as input data for the at least two multiple outlier detection methods. This provides a lean, efficient architecture for the implementation of the multiple outlier detection methods to the deep neural network.

Furthermore, it is conceivable that the at least two multiple outlier detection methods are fitted to the activation of the output layer of the trained deep neural network. That is, the output data of the last layer of the deep neural network can be used for fitting the at least two multiple outlier detection methods. This has the benefit that no further data processing operations are conducted, which would require further computational power and also slowing down the process of determining the validity of the prediction made by the deep neural network.

According to a further exemplary embodiment, a system for assessing the reliability of a prediction made by a neural network is provided, comprising a processor and a data storage, wherein the data storage comprises instructions which, when executed by the processor, cause the processor to:
input input data to a trained deep neural network, wherein the trained deep neural network is configured to output a detection based on a highest class score,
determine class score a probability of the detection, wherein the class probability score is determined by fitting of at least two multiple outlier detection methods, wherein the at least two multiple outlier detection methods are configured to produce the class probability score,
determine, based on the class probability score, whether the input data is an outlier or not,
compare the class probability score to a threshold value,
output that the prediction is reliable if the class probability score is above the threshold value, or outputting that the prediction is not reliable if the class probability score is below the threshold value.

As a consequence, the disclosed system has the same benefits which are discussed in detail in connection to the disclosed method.

Further, it is conceivable that the processor and the data storage are configured to be arranged in a transportation vehicle, and/or that the system comprises a transportation vehicle with the processor and the data storage. That is, the mechanism for performing the method can be arranged on a computer that is part of the transportation vehicle or that the transportation vehicle is part of the system itself.

It can also be provided that the training of the deep neural network or training of further parts of the model are performed on a computer that is a backend computer which is not arranged on a transportation vehicle. This provides that the training operations, which usually require large computational power and resources, are performed at a location where high energy consumption and weight do not pose a problem.

According to a further exemplary embodiment, a computer-readable medium is provided, comprising instructions which, when executed by a computer, in particular, by a processor that is arranged in a car, cause the computer to carry out the disclosed method.

As a consequence, the computer-readable medium provides the same benefits that are discussed in detail in relation to the disclosed method and/or the disclosed system.

Further exemplary embodiments can also comprise a computer program and/or a computer program product, which also provides the same features that are discussed in detail in relation to the disclosed method and/or the disclosed system.

In the following description of some exemplary embodiments, the identical reference signs are used for the same technical features even in different disclosed embodiments.

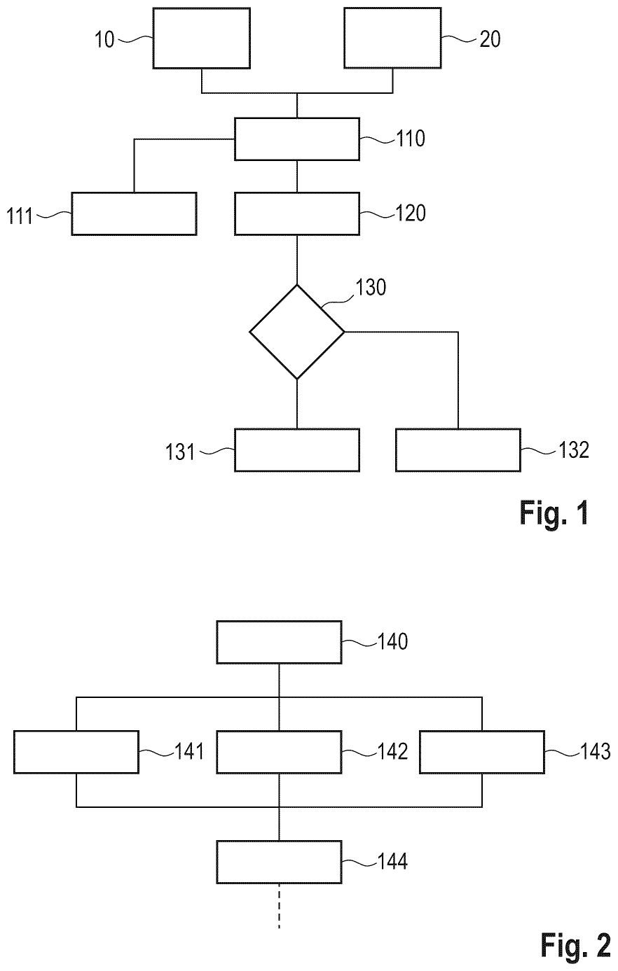

FIG. 1 shows a schematic representation of a disclosed method. This method for assessing the reliability of a prediction made by a deep neural network, comprises inputting 110 input data 20 to a trained deep neural network, wherein the trained deep neural network is configured to output a detection based on a highest class score. Further, the method comprises determining 111 a class probability score of the detection, wherein the class probability score is determined by fitting of at least two multiple outlier detection methods 141, 142, 143, wherein the at least two multiple outlier detection methods 141, 142, 143 are configured to produce the class probability score. The method also comprises determining 120, based on the class probability score, whether the input data 20 is an outlier or not and comparing 130 the class probability score to a threshold value. Additionally, the method comprises outputting that the prediction is reliable if the class probability score is above the threshold value 131, or outputting that the prediction is not reliable if the class probability score is below the threshold value 132.

As a result, this disclosed method allows to determine the reliability of a prediction of a deep neural network at relatively low computational cost. This results in the applicability of the method in real-time situations, such as self-driving or partly self-driving transportation vehicles.

An exemplary embodiment of the method comprises:
(1) Extracting activations of a latest deep neural network layer, in particular, of a convolutional neural network layer, for a complete training dataset,
(2a) Fitting results from multiple outlier detection methods 141, 142, 143 are fitted to the results from the last deep neural network layer wherein the multiple outlier detection methods 141, 142, 143 produce probability scores,
(2b) Calculate the probability scores of the multiple outlier detection methods 141, 142, 143 and choosing the ones which get a better detection rank,
(3) Training a meta outlier detector trained on the probability scores from (2a, 2b) to get a final detection decision if a data point is an outlier or not,
(4) Extracting, for every new data point inferred to the deep neural network, the same deep neural network layer activations that are extracted and based on (1),
(5) Estimating the probability score of the results from (4) is with respect to the class clusters using the proposed class-id from the deep neural network's final prediction by inferring into (2) and then (3), and
(6) Outputting, if the probability score estimated in operation at (5) is less than the threshold calculated in operation at (3), that the final prediction is considered as “not reliable” or, if the probability score estimated in operation at (5) is more than the threshold calculated in operation at (3), that the final prediction is considered as “reliable”.

Optionally, the probability scores in operation at (2a, 2b) are calculated in a way that requires minimum computation power in the transportation vehicle 200.

The decision if a prediction made by the deep neural network, in particular, of an automated driving system in a transportation vehicle 200, is reliable or not can be made by the above-mentioned six operations. In particular, operations one to three can be performed during the creation of the system in a backend system, while operations four to six can be performed in the transportation vehicle 200 during the runtime, as these require minimum computational power.

A disclosed method has the benefit of being applicable to different detection tasks such as semantic segmentation, 2D and 3D object detection. Also, the results can be used for safety argumentation of deep neural networks based on various difficulty level data points.

FIG. 2 shows another schematic of a part of the disclosed method. It can be seen that multiple outlier detection methods 141, 142, 143 are provided and that input data 20 is input 140 into these multiple outlier detection methods 141, 142, 143.

It can be provided that at least two of the at least two multiple outlier detection methods 141, 142, 143 differ from each other, wherein a first multiple outlier detection method 141 is isolation forest and a second multiple outlier detection method 142 is a one class support vector machine.

Additionally or alternatively, it can be provided that at least two of the at least two multiple outlier detection methods 141, 142 are of the same type, wherein different subsets of the input data 20 are prepared and each of the different subsets is input in an outlier detection method 141, 142, 143 of the same type, in particular, wherein the two multiple outlier detection methods 141, 142 are an isolation forest.

In this case, the subsets of the input data 20 can be selected by feature bagging.

As can be seen in the lower part of FIG. 2, it can be provided that a meta multiple outlier detection method 144 is provided, which receives at least two probability scores from the at least two multiple outlier detection methods 141, 142, 143 and determines a meta probability score.

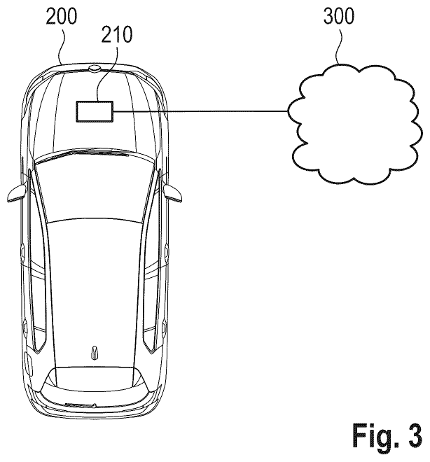

FIG. 3 represents an environment in which a system as well as a disclosed computer readable storage medium can be applied.

A disclosed system is configured for assessing the reliability of a prediction made by a deep neural network and comprises a processor and a data storage. The processor and data storage can be regarded as a computer 210. This computer 210 can be arranged on a transportation vehicle 200. The data storage comprises instructions which, when executed by the processor, cause the processor to:
input input data to a trained deep neural network, wherein the trained deep neural network is configured to output a detection based on a highest class score,
determine a probability score of the detection, class wherein the class probability score is determined by fitting of at least two multiple outlier detection methods 141, 142, 143, wherein the at least two multiple outlier detection methods 141, 142, 143 are configured to produce the class probability score,
determine, based on the class probability score, whether the input data is an outlier or not,
compare the class probability score to a threshold value,
output that the prediction is reliable if the class probability score is above the threshold value 131, or outputting that the prediction is not reliable if the class probability score is below the threshold value 132.

It is further conceivable that the system comprises the transportation vehicle 200 with the processor and the data storage.

Further, it is possible that at least parts of the method are performed in a backend or cloud 300. In particular, training of the deep neural network and/or the fitting of the multiple outlier detection methods 141, 142, 143 can be performed in the backend or cloud 300.

The foregoing explanation of the exemplary embodiments describes the present disclosure exclusively in the context of embodiments. Of course, individual features of the exemplary embodiments may be freely combined with one another, provided that this is technically expedient, without departing from the scope of the present disclosure.

### REFERENCE SIGNS

10 Input training data
20 Input data
110 Inputting
111 Determining (a class probability score)
120 Determining (outlier)
130 Comparing
131 Probability score above the threshold
132 Probability score below the threshold
140 Input data
141 First multiple outlier detection method
142 Second multiple outlier detection method
143 Third multiple outlier detection method
144 Meta multiple outlier detection method
200 Transportation vehicle
210 Computer
300 Cloud

1. A system for assessing reliability of a detection made by a deep neural network, the system comprising:
a processor; and
a data storage, wherein the data storage comprises instructions which, when executed by the processor, cause the processor to:
input input data from a sensor to a trained deep neural network, wherein the trained deep neural network outputs a detection based on a highest class score,
determine a class probability score of the detection by fitting of at least two multiple outlier detection methods, wherein the at least two multiple outlier detection methods produce the class probability score,
determine, based on the class probability score, whether the input data is an outlier by comparing the class probability score to a threshold value, and
output an output indicating whether the detection is reliable in response to the determination of whether the input data is an outlier.

2. The system of claim 1, wherein the processor and the data storage are arranged in a transportation vehicle, and/or wherein the system comprises a transportation vehicle with the processor and the data storage.

3. The system of claim 1, wherein the class probability score is determined with respect to the at least two classes.

4. The system of claim 1, wherein at least one of the at least two multiple outlier detection methods is:
a gaussian mixture model,
a one class support vector machine,
a local intrinsic dimensionality,
a k-Means clustering,
a Mahalanobis distance, or
an isolation forest.

5. The system of claim 1, wherein at least two of the at least two multiple outlier detection methods differ from each other, wherein a first multiple outlier detection method is isolation forest and a second multiple outlier detection method is a one class support vector machine.

6. The system of claim 1, wherein at least two of the at least two multiple outlier detection methods are of the same class, wherein different subsets of the input data are prepared and each of the different subsets is input in an outlier detection method of the same class, wherein the two multiple outlier detection methods are an isolation forest.

7. The computer-implemented method of claim 8, wherein the subsets of the input data are selected by feature bagging.

8. The system of claim 1, wherein a meta multiple outlier detection method is provided, which receives at least two probability scores from the at least two multiple outlier detection methods and determines a meta probability score.

9. The system of claim 1, wherein
the input data comprises information of at least a traffic signal, a traffic light, a traffic participant, or a transportation vehicle, and/or
the input data is at least an image, a radar sensor signal, a LIDAR sensor signal or an ultrasonic sensor signal.

10. The system of claim 1, wherein the at least two multiple outlier detection methods are fitted to the activation of the output layer of the trained deep neural network.

11. A computer-implemented method for assessing the reliability of a detection made by a deep neural network, the method comprising:
inputting input data from a sensor to a trained deep neural network;
using the trained deep neural network to output a detection based on a highest class score;
determining a class probability score of the detection by fitting of at least two multiple outlier detection methods, wherein the at least two multiple outlier detection methods produce the class probability score;
determining, based on the class probability score, whether the input data is an outlier by comparing the class probability score to a threshold value;
outputting an output indicating whether the detection is reliable in response to the determination of whether the input data is an outlier.

12. The computer-implemented method of claim 11, wherein the class probability score is determined with respect to the at least two classes.

13. The computer-implemented method of claim 11, wherein at least one of the at least two multiple outlier detection methods is:
a gaussian mixture model,
a one class support vector machine,
a local intrinsic dimensionality,
a k-Means clustering,
a Mahalanobis distance, or
an isolation forest.

14. The computer-implemented method of claim 11, wherein at least two of the at least two multiple outlier detection methods differ from each other, wherein a first multiple outlier detection method is isolation forest and a second multiple outlier detection method is a one class support vector machine.

15. The computer-implemented method of claim 11, wherein at least two of the at least two multiple outlier detection methods are of the same class, wherein different subsets of the input data are prepared and each of the different subsets is input in an outlier detection method of the same class, wherein the two multiple outlier detection methods are an isolation forest.

16. The computer-implemented method of claim 15, wherein the subsets of the input data are selected by feature bagging.

17. The computer-implemented method of claim 11, wherein a meta multiple outlier detection method is provided, which receives at least two probability scores from the at least two multiple outlier detection methods and determines a meta probability score.

18. The computer-implemented method of claim 11, wherein
the input data comprises information of at least a traffic signal, a traffic light, a traffic participant, or a transportation vehicle, and/or
the input data is at least an image, a radar sensor signal, a LIDAR sensor signal or an ultrasonic sensor signal.

19. The computer-implemented method of claim 11, wherein the at least two multiple outlier detection methods are fitted to the activation of the output layer of the trained deep neural network.

20. A non-transitory computer-readable medium comprising instructions which, when executed by a computer, cause the computer to perform the method of claim 11.
